(19) United States
(12) Patent Application Publication
(10) Pub. No.: US 2019/0187614 A1
(43) Pub. Date: Jun. 20, 2019

(54) APPARATUS FOR HOLOGRAPHIC DISPLAY BY COMPLEX MODULATION AND METHOD THEREOF

(71) Applicant: ELECTRONICS AND TELECOMMUNICATIONS RESEARCH INSTITUTE, Daejeon (KR)

(72) Inventor: Kwan-Jung OH, Daejeon (KR)

(21) Appl. No.: 16/213,357

(22) Filed: Dec. 7, 2018

(30) Foreign Application Priority Data
Dec. 14, 2017 (KR) 10-2017-0172503
Nov. 27, 2018 (KR) 10-2018-0148888

(51) Int. Cl. G03H 1/22; G03H 1/04

(52) U.S. Cl. CPC G03H 1/2202; G03H 1/0443; G03H 1/2286; G03H 2001/2234; G03H 2223/23; G03H 2226/02; G03H 2223/13; G03H 2240/13

(57) ABSTRACT

In the present invention, by providing an apparatus for displaying a complex modulated holograph and including a light source configured to output light, a display configured to display the hologram by diffracting the output light through a plurality of pixels, and a processor configured to control the display to obtain complex hologram data corresponding to the hologram, and modulate the output light based on the complex hologram data and device information of the plurality of pixels, it is possible to modulate amplitude information and phase information of the light source into required values and display a complex hologram, and to remove a noise component of the hologram.

### CROSS-REFERENCE TO RELATED APPLICATION

This application claims priority to and the benefit of Korean Patent Application Nos. 10-2017-0172503 and 10-2018-0148888 filed in the Korean Intellectual Property Office on Dec. 14, 2017, and Nov. 27, 2018, respectively, the entire contents of which are incorporated herein by reference.

### BACKGROUND OF THE INVENTION

### (a) Field of the Invention

The present invention relates to a method and apparatus for holographic display by complex modulation in a digital holographic display technology.

### (b) Description of the Related Art

Recently, as 3D display technology has developed, objects have been expressed with perfect parallax and depth, and there has been no symptoms of eye fatigue and dizziness. Furthermore, the graphic display technology alone may display different images according to movement of the viewpoint, and it has evolved into the ultimate 3D display technology with a number of viewing windows that do not require ancillary equipment for viewing (e.g., glasses).

Digital holographic display technology is a technology that gives the same effect as if a wave-front produced by a given object is reproduced as it is in the human eye. In addition, the digital holographic graphic display technology generates a digital hologram capable of expressing both amplitude information and phase information of light, and reproduces a 3D image in space by using a spatial light modulator (SLM).

On the other hand, the spatial light modulator may modulate only one of the amplitude and phase, so there is a drawback that complex holograms containing amplitude information and phase information cannot be represented accurately. For example, there is a method of simultaneously performing amplitude modulation and phase modulation by layering an amplitude modulation spatial light modulator and a phase modulation spatial light modulator, but there is a drawback that is costly.

In addition, the spatial light modulator must be able to precisely modulate the predetermined amplitude or phase in advance. However, due to the pixel characteristics of the panel of the spatial light modulator, there is a drawback in which the phase changes according to the amplitude control.

The above information disclosed in this Background section is only for enhancement of understanding of the background of the invention and therefore it may contain information that does not form the prior art that is already known in this country to a person of ordinary skill in the art.

This work was supported by ‘The Cross-Ministry Giga KOREA Project’ grant funded by the Korea government (MSIT) (No. GK18C0200, Development of full-3D mobile display terminal and its contents).

### SUMMARY OF THE INVENTION

The present invention has been made in an effort to provide an apparatus for displaying a complex modulated holograph and a method thereof having advantages of expressing both amplitude and phase of the complex hologram. The present invention has been made in an another effort to provide an apparatus for displaying a complex modulated holograph and a method thereof having advantages of solving phase changes according to amplitude control of a spatial light modulator.

An apparatus for holographic display by complex modulation includes: a light source configured to output light; a display configured to display a hologram by diffracting the output light through a plurality of pixels; and a processor configured to control the display to obtain complex hologram data corresponding to the hologram, and modulate the output light based on the complex hologram data and device information of the plurality of pixels.

The display includes a plurality of first modulation pixels modulating a phase of the output light and a plurality of second modulation pixels modulating amplitude and phase of the phase modulated light, and the device information of the plurality of pixels includes phase variation information according to amplitude variation of the plurality of second modulation pixels.

The processor obtains a plurality of modulated light waves from the output light using the plurality of first modulation pixels, and displays the hologram by combining the plurality of modulated light waves.

The processor modulates the phase of the output light so that the plurality of modulated light waves are evenly distributed in a complex space.

The processor determines the magnitude of amplitude modulation of the plurality of second modulation pixels using a phase difference between the plurality of modulated light waves, the complex hologram data, and the phase variation information according to amplitude variation of the plurality of second modulation pixels.

The plurality of first modulation pixels include a holographic optical element or a diffractive optical element.

The plurality of first modulation pixels and the plurality of second modulation pixels are disposed adjacent to each other.

A pixel pitch between the adjacent plurality of first modulation pixels is same as the pixel pitch between the adjacent plurality of second modulation pixels.

A method for holographic display by complex modulation for displaying a hologram using a plurality of pixels includes: outputting coherent light; modulating an amplitude of the output light based on complex hologram data corresponding to the hologram and device information of the plurality of pixels; modulating a phase of the amplitude-modulated light; diffracting the complex modulated light through the plurality of pixels; and reproducing the hologram using the diffracted light.

The device information of the plurality of pixels includes phase variation information according to amplitude variation of the plurality of pixels.

The method includes obtaining a plurality of modulated light waves from the output light, and reproducing the hologram by combining the plurality of modulated light waves.

The method includes modulating the phase of the output light so that the plurality of modulated light waves are evenly distributed in a complex space.

The method includes determining a magnitude of amplitude modulation using a phase difference between the plurality of modulated light waves, the complex hologram data, and the phase variation information according to amplitude variation of the plurality of pixels.

An apparatus for holographic display by complex modulation includes: a light source configured to output coherent unit light; a display configured to reproduce a unit hologram by diffracting the output unit light through three pixels; and a processor configured to control the display to obtain complex hologram data corresponding to the unit hologram, and modulate the output unit light based on the complex hologram data and device information of the three pixels.

The display includes a spatial light modulator including three first modulation pixels modulating the amplitude and phase of the output unit light, and a phase mask including three second modulation pixels modulating the phase of the amplitude-modulated unit light.

The device information of the three pixels includes phase variation information according to amplitude variation of the three first modulation pixels.

The processor obtains three modulated light waves from the output unit light using the three second modulation pixels, and displays the unit hologram by combining the three modulated light waves.

The processor modulates the phase of the output light so that the three modulated light waves divide a complex space into three equal parts.

The three first modulation pixels and the three second modulation pixels are disposed adjacent to each other.

A pixel pitch between the three adjacent first modulation pixels is greater than a pixel pitch between the three adjacent second modulation pixels, and the three adjacent second modulated pixels diffract light diffracted to a first angle through the three first modulated pixels to a second angle that is greater than the first angle.

According to exemplary embodiments of the present invention, due to amplitude information and phase information of the light source being modulated to required values, a complex hologram may be reproduced, and a noise component of the hologram may be easily removed.

Also, according to exemplary embodiments of the present invention, by disposing a phase mask only for phase modulation in parallel with a spatial light modulator for amplitude modulation, it is possible to accurately display the phase without having to propagate light into the spatial light modulator at an angle.

Further, by newly defining the unit light wave so that it may be applied to the case where the phase is kept constant or changed during amplitude modulation, it is possible to control irregularly changing phases according to the amplitude control in the amplitude modulation panel.

### BRIEF DESCRIPTION OF THE DRAWINGS

FIG. 1 shows an example of an apparatus for holographic display by complex modulation according to the present invention.

FIG. 2 shows a complex plane with four light vectors according to an exemplary embodiment of the present invention.

FIG. 3 shows the complex plane with three light vectors according to an exemplary embodiment of the present invention.

FIG. 4 shows an example of modulation of a modulation wave according to the present invention.

FIG. 5 shows a process of obtaining a complex modulation hologram using three modulation pixels.

FIG. 6 shows an exemplary embodiment of the phase mask according to the present invention.

FIG. 7 shows light, phase modulation light, and amplitude modulation light according to an exemplary embodiment of the present invention.

FIG. 8 represents a unit light vector representing unit light according to an exemplary embodiment of the present invention.

FIG. 9 shows a complex space that may be represented by a unit light vector according to an exemplary embodiment of the present invention.

FIG. 10 shows a three-unit light vector reflecting the phase delay phenomenon according to an exemplary embodiment of the present invention.

FIG. 11 shows a complex space expressed by a modified unit light vector as shown in FIG. 10.

FIG. 12 shows a reproduced hologram according to the conventional art.

FIG. 13 shows a reproduced hologram according to the conventional art.

FIG. 14 shows a reconstructed hologram according to an exemplary embodiment of the present invention.

FIG. 15 shows a block diagram of an apparatus for holographic display by complex modulation according to an exemplary embodiment of the present invention.

FIG. 16 shows a flowchart illustrating a method for holographic display by complex modulation according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

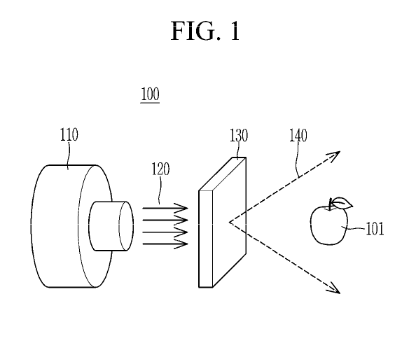

FIG. 1 shows an example of an apparatus for holographic display by complex modulation according to the present invention.

As shown in FIG. 1, an apparatus for holographic display by complex modulation 100 may include a light source 110 and a spatial light modulator 130.

A hologram is an interference pattern of light from an object or space or an image that is reconstructed from the interference pattern. The holographic technique is a technique of reproducing the hologram using the diffraction and interference phenomenon of light waves.

In order to reproduce the hologram in space, the light source 110 emits light (for example, laser light) with an interference characteristic in which the coherence is higher than a predetermined value. The light source 110 may emit coherent light 120 and transmit it to the spatial light modulator 130.

The spatial light modulator 130 includes a plurality of pixels. The spatial light modulator 130 may be an LC (liquid crystal), an LCoS (liquid crystal on silicon), or a DMD (digital micro-mirror device) so as to reproduce a hologram (or a digital hologram)

Each of the pixels of the spatial light modulator 130 may diffract the transmitted light 120. The plurality of pixels may diffract the transmitted light by a predetermined angle, and the diffraction angle is determined according to a pixel pitch between the plurality of pixels.

The spatial light modulator 130 diffracts the light 120 using the plurality of pixels and modulates the light 120 to obtain modulated light 140, so the modulated light 140 may form interference such that the hologram 101 may be reproduced in space.

The spatial light modulator 130 may modulate the amplitude of the light 120 or modulate the phase of the light 120. For example, the spatial light modulator 130 may increase the amplitude of the light 120 by a (‘a’ is a positive real number) times. For example, the spatial light modulator 130 may delay (or move) the phase of the light 120 by X (X is a real number between −2π and 2π).

However, in this specification, the spatial light modulator 130 is assumed to be capable of modulating (or controlling) only the amplitude of the light 120 and the phase of the light 120.

The hologram data for reproducing the hologram has a complex value. That is, the hologram data may be defined as a complex hologram (x+jy) having an amplitude value and a phase value. The spatial light modulator 130 may modulate only the amplitude of light based on the complex hologram. Hereinafter, a method for expressing a complex value of the hologram data while modulating only the amplitude value of the light 120 will be described.

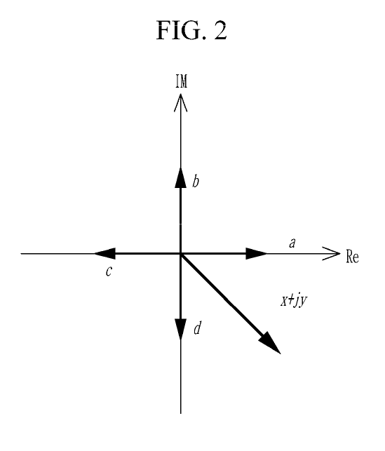

FIG. 2 shows a complex plane with four light vectors according to an exemplary embodiment of the present invention.

Since all the lights used in this specification are generated from one reference light, they may be expressed as phasers with the same wavelength, and the complex value may be expressed as a*ê(jX). That is, in order to express an accurate complex hologram, it is necessary to accurately express the magnitude (a) and phase (x) of the complex value (vector) to be expressed.

As shown in FIG. 2, an apparatus for holographic display by complex modulation 100 may obtain four modulation light waves to represent a complex hologram using light 120, express a complex hologram using four modulation light waves, and display a hologram using a complex hologram. Complex holograms may be expressed in vector form, and may be expressed as x+jy.

The apparatus for holographic display by complex modulation 100 may express a complex hologram x+jy using four light vectors corresponding to four modulation light waves. For example, the apparatus for holographic display by complex modulation 100 may determine values of a, b, c, and d for a first light vector of a*ê(0), a second light vector of b*ê(jπ/2), a third light vector of c*ê(−jπ), and a fourth light vector of d*ê(−jπ/2).

In other words, x+jy may be expressed as a*ê(0)+b*ê(jπ/2)+c*ê(−jπ)+d*ê(−jπ/2). The complex modulation alone graphic display device 100 may determine the values of a, b, c, and d of the first to fourth light vectors based on predetermined conditions and x and y values.

The apparatus for holographic display by complex modulation 100 may obtain first to fourth modulation light waves modulated by a, b, c, and d using the light 120, through four adjacent pixels among the plurality of pixels of the spatial light modulator 130, and express a complex hologram by a complex value x+jy using the first to fourth modulation light waves.

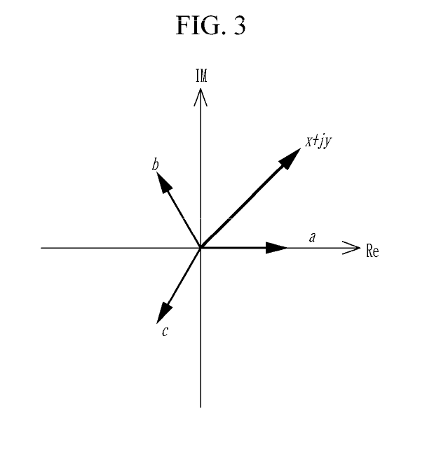

FIG. 3 shows the complex plane with three light vectors according to an exemplary embodiment of the present invention.

As shown in FIG. 3, an apparatus for holographic display by complex modulation 100 may obtain three modulation light waves for expressing a complex hologram using light 120. The apparatus for holographic display by complex modulation 100 may express a complex hologram using three modulation light waves and display a hologram using the complex hologram.

The apparatus for holographic display by complex modulation 100 may express the complex hologram x+jy using three light vectors corresponding to three modulation light waves. For example, the apparatus for holographic display by complex modulation 100 may determine a, b, and c values of first light vector of a*ê(0), the second light vector of b*ê(j2π/3), and the third light vector of c*ê(−j2π/3), and express the x+jy value using a combination of the first to third light vectors.

In other words, x+jy may be expressed as a*ê(0)+b*ê(j2π/3)+c*ê(−j2π/3). The apparatus for holographic display by complex modulation 100 may determine values of a, b, and c of the first to third light vectors based on a predetermined condition and x and y values.

The apparatus for holographic display by complex modulation 100 may obtain first to third modulation light waves modulated by a, b, and c using the light 120, through three adjacent pixels among the plurality of pixels of the spatial light modulator 130, and express a complex hologram by a complex value x+jy using the first to third modulation light waves.

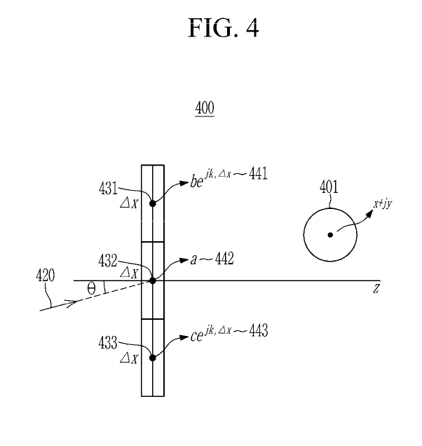

FIG. 4 shows an example of modulation of a modulation wave according to the present invention.

In order to obtain four modulation light waves expressed by four light vectors with phase differences of 90 degrees as shown in FIG. 2, or three modulation light waves expressed by three light vectors with phase differences of 120 degrees as shown in FIG. 3, as shown in FIG. 4, the apparatus for holographic display by complex modulation 400 may obtain four or three modulation light waves by propagating the light 120 to the spatial light modulator by an angle of θ.

As shown in FIG. 4, in order to express the complex hologram 401 represented by the complex value (x+jy), the apparatus for holographic display by complex modulation 400 may propagate the light 420 output from the light source 120 on the spatial light modulator by the angle of θ with a plurality of pixels 431, 432, and 433.

In this case, a phase difference between a unit light wave incident on the first complex modulation pixel 431 and a unit light wave incident on the second complex modulation pixel 432, and a phase difference between a unit light wave incident on the second complex modulation pixel 432 and a unit light wave incident on the third complex modulation pixel 433, may be k*Δx (k is spatial frequency, Δx is pixel pitch).

When using four modulation pixels as shown in FIG. 2, the apparatus for holographic display by complex modulation 400 determines k*Δx as 90 degrees (or π/2). When using three modulation pixels as shown in FIG. 3, the apparatus for holographic display by complex modulation 400 determines k*Δx as 120 degrees (or 2π/3).

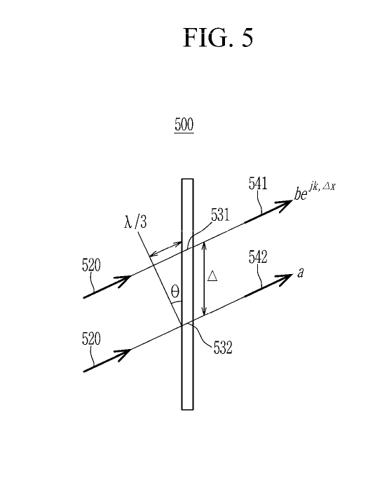

When plurality of unit light waves having a phase difference of k*Δx are obtained as described above, the first modulation pixel 431, the second modulation pixel 432, and the third modulation pixel 433 may modulate the amplitude by multiplying the amplitude of a, b, or c by the plurality of unit light waves to obtain a first modulated light wave 442 of FIG. 4 and 542 of FIG. 5 (a), a second modulated light wave 441 of FIG. 4 and 541 of FIG. 5 (b*ê(jk₁*Δx)), and a third modulated light wave 443 (c*ê(jk₂*Δx)).

According to the method described above, the first to third modulation pixels 431 to 433 may generate a complex value of a+b*ê(jk₁*Δx)+c*ê(jk₂*Δx), express the complex hologram 401 defined as x+jy using the complex value of a+b*ê(jk₁*Δx)+c*ê(jk₂*Δx), and display the hologram 101 using the complex hologram 401.

FIG. 5 shows a process of obtaining a complex modulation hologram using three modulation pixels.

As shown in FIG. 5, the apparatus for holographic display by complex modulation 500 may propagate light 520 output from the light source to a first modulation pixel 531 and a second modulation pixel 532 of the spatial light modulator. In this case, the incident angle θ may be determined so that a difference between propagation distances of the first unit light wave incident to the first modulation pixel 531 and the second unit light wave incident to the second modulation pixel 532 may be λ/3 (λ is wavelength of the light 520). This allows the phase difference between three unit light waves incident on the three modulation pixels to be 120 degrees, and the three unit light waves may divide a complex space into three equal parts.

In this case, the incident angle θ for making the phase difference between the three unit light waves incident on the three modulation pixels to be 120 degree may be represented by sin⁻¹(λ/3Δ)1

If complex holograms are expressed using four modulation pixels, θ would be sin⁻¹(λ/4Δ).

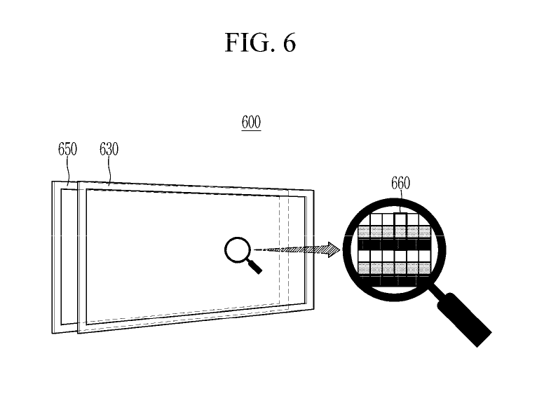

However, it is difficult to make the light incident at exactly the desired incident angle in the system configuration as shown in FIG. 4 and FIG. 5. Therefore, a method of generating a plurality of unit light waves having the same phase difference without propagating light with any angle and performing complex modulation by using the above is described with reference to FIG. 6 to FIG. 16.

Hereinafter, for convenience of explanation, although an exemplary embodiment of generating three modulated light waves by using three modulation pixels and representing a complex hologram by using three modulation light waves is described as an example, it is not necessarily limited thereto.

FIG. 6 shows an exemplary embodiment of the phase mask according to the present invention.

As shown in FIG. 6, an apparatus for holographic display by complex modulation 600 may include a phase mask 650 located at a position facing a first surface (a surface of the spatial light modulator facing the light source) or a second surface (a surface on the other side of the first surface) of a spatial light modulator 630.

The phase mask may consist of a DOE (diffractive optical element) or an HOE (holographic optical element).

The spatial light modulator 630 may include a plurality of amplitude modulation pixels for modulating amplitude, and the phase mask 650 may include a plurality of phase modulation pixels for modulating phase. The three consecutive amplitude modulation pixels of the spatial light modulator 630 may be disposed at a position facing the three consecutive phase modulation pixels of the phase mask 650. The three phase modulation pixels of the phase mask 650 and the three amplitude modulation pixels of the spatial light modulator 630 may be defined as a macro pixel 660.

The phase mask 650 may generate a constant phase delay for consecutive pixels. When the phase mask 650 is positioned to face the second surface of the spatial light modulator 630, the three consecutive phase modulation pixels of the phase mask 650 may phase-modulate three amplitude-modulated light waves and output the three phase-modulated light waves, where the three amplitude-modulated light waves are output from the three amplitude modulation pixels of the spatial light modulator 630 by amplitude modulation, so that the phase difference is 0 degrees, 120 degrees, and 240 degrees, respectively. When the phase mask 650 is positioned to face the first surface of the spatial light modulator 630, the three consecutive phase modulation pixels of the phase mask 650 may phase-modulate the output light from the light source so that the phase difference is 0 degrees, 120 degrees, and 240 degrees, respectively, and output three phase modulated light waves (or three unit light waves) to the spatial light modulator 630.

Three consecutive phase modulation pixels and amplitude modulation pixels within a macro pixel 660 may be composed in the horizontal direction, the vertical direction, in a lattice shape, or a ‘/’ shape, and the shape is not particularly limited.

For example, the phase modulation pixels of the phase mask 650 and the amplitude modulation pixels of the spatial light modulator 630 may have the same pixel pitch. In another example, the phase modulation pixels of the phase mask 650 and the amplitude modulation pixels of the spatial light modulator 630 have different pixel pitches, so that the phase mask 650 enlarges a diffraction angle of the spatial light modulator 630 to the output light from the light source, and the viewing angle may be enlarged.

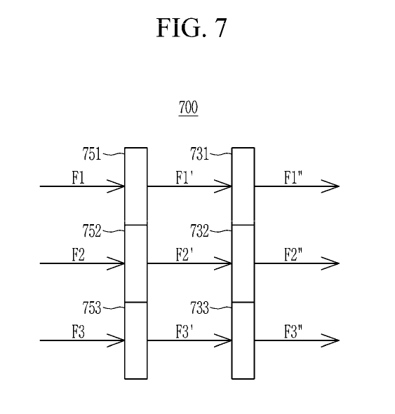

FIG. 7 shows light, phase modulation light, and amplitude modulation light according to an exemplary embodiment of the present invention.

As shown in FIG. 7, light F1, F2, and F3 output from the light source (for example, the light source 110 of FIG. 1) of the apparatus for holographic display by complex modulation 700 may be received by a first phase modulation pixel 751, a second phase modulation pixel 752, and a third phase modulation pixel 753 of a phase mask (the phase mask 650 of FIG. 6).

The first phase modulation pixel 751 may modulate the phase of the first light F1 by a first angle and output a first phase modulated light wave F1′. For example, the first angle may be zero.

The second phase modulation pixel 752 may modulate the phase of the second light F2 by a second angle and output a second phase modulated light wave F2′. For example, the second angle may be 2π/3.

The third phase modulation pixel 753 may modulate a phase of the third light F1 by a third angle and output the third phase modulated light wave F3′. For example, the third angle may be 4π/3 or −2π/3.

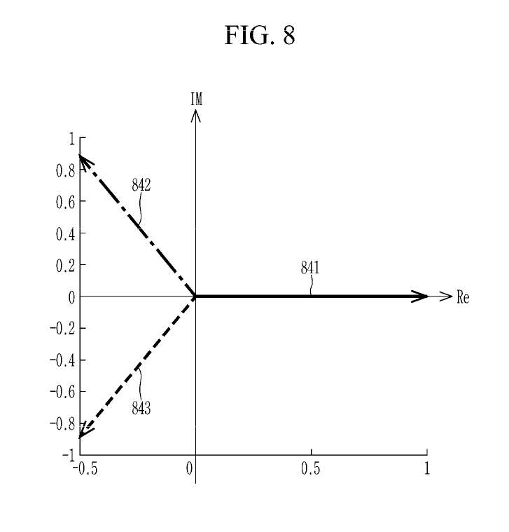

FIG. 8 represents a unit light vector representing unit light according to an exemplary embodiment of the present invention.

As shown in FIG. 8, the apparatus for holographic display by complex modulation may define a first unit light wave as a first unit light vector 841 of 1*ê(0), define a second unit light wave as a second unit light vector 842 of 1*ê(2π/3), and define a third unit light wave as a third unit light vector 843 of 1*ê(4π/3) or 1*ê(−2π/3).

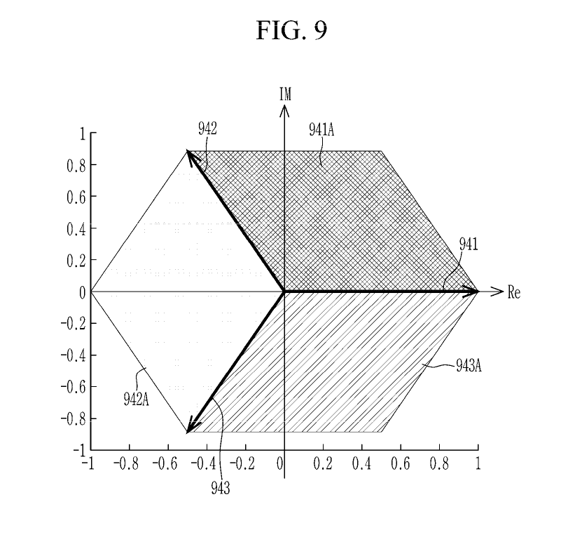

FIG. 9 shows a complex space that may be represented by a unit light vector according to an exemplary embodiment of the present invention.

As shown in FIG. 9, the apparatus for holographic display by complex modulation may express a first complex area 941A using a combination of a first unit light vector 941 (F1″ of FIG. 7) and a second unit light vector 942 (F2″ of FIG. 7). For example, the apparatus for holographic display by complex modulation may amplitude-modulate the first unit light vector 941 by multiplying by a first amplitude, amplitude-modulate the second unit light vector 942 by multiplying by a second amplitude, and express all complex values on the first area 941A.

Also, the apparatus for holographic display by complex modulation may express a second complex area 942A using combination of the second unit light vector 942 and a third unit light vector 943 (F3″ of FIG. 7). For example, the apparatus for holographic display by complex modulation may amplitude-modulate the second unit light vector 942 by multiplying by the second amplitude, amplitude-modulate the third unit light vector 943 by multiplying by a third amplitude, and express all complex values on the second complex area 942A.

Further, the apparatus for holographic display by complex modulation may express a third complex area 943A using a combination of the third unit light vector 943 and the first unit light vector 941. For example, the apparatus for holographic display by complex modulation may amplitude-modulate the third unit light vector 943 by multiplying by the third amplitude, amplitude-modulate the first unit light vector 941 by multiplying by the first amplitude, and express all complex values on the third complex area 943A.

That is, the apparatus for holographic display by complex modulation may express a complex hologram (x+jy) using Equation 1 below.

$$x + jy = a + {be}^{j \frac{2 π}{3}} + {ce}^{j \frac{4 π}{3}} \qquad [ Equation 1 ]$$

That is, the apparatus for holographic display by complex modulation may express a complex hologram (x+jy) using a value found by multiplying first amplitude (a) by the first unit light vector (ê(j0)), a value found by multiplying the second amplitude (a) by the second unit light vector (ê(j2π/3)), and a value found by multiplying the third amplitude (a) by the third unit light vector (ê(j4π/3)). In other words, the apparatus for holographic display by complex modulation may determine the values of the first amplitude (a), the second amplitude (b), and the third amplitude (c) using Equation 1.

Here, each unit light vector (basis vector) used for complex modulation must be defined so that each phase difference (120 degrees or 2π/3) is maintained. However, the starting phase value of the reference vector (e.g., the first unit light vector) among each of the light unit vectors (basis vectors) need not be zero.

As an example, the phases of the first to third unit light vectors may sequentially be 0, 120, and 240 degrees. As another example, the phases of the first to third unit light vectors may sequentially be 20, 140, and 260 degrees.

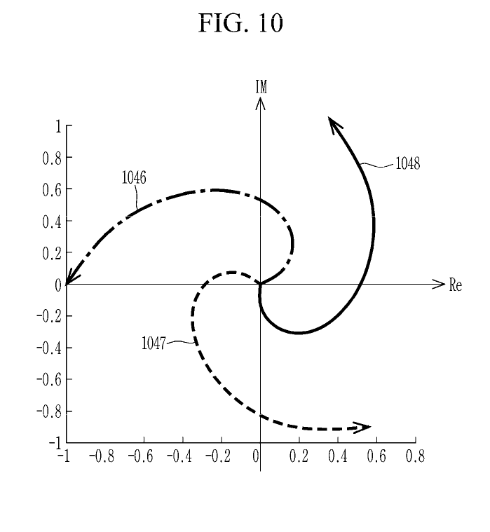

FIG. 10 shows a three-unit light vector reflecting the phase delay phenomenon according to an exemplary embodiment of the present invention.

The three unit light vectors described above with reference to FIG. 8 and FIG. 9 do not reflect the phase delay phenomenon that occurs based on the amplitude modulation of the spatial light modulator. In the case of a general spatial light modulator (e.g., an amplitude modulation panel), the LC (liquid crystal) panel method is used, and thus the phase value varies in proportion to the amplitude during the variation of the amplitude.

For example, the phase may vary from 0 to π while the amplitude changes from 0 to 1. When the amplitude varies from 0 to 1 while the phase varies from 0 to π, the three unit light vectors may be changed as shown in FIG. 10.

It is assumed that the phase of the unit light vector varies from 0 to π in proportion to the amplitude while the amplitude value changes from 0 to 1 in this specification, but it is not necessarily limited thereto. That is, the phase change ratio according to the amplitude change of each amplitude modulation pixel (731, 732, 733 of FIG. 7) is explained as π/1.

As shown in FIG. 10, for example, the phase value of a first unit light vector 1046 is 0 when the amplitude value of the first unit light vector 1046 among a plurality of unit light vectors 1046, 1047, and 148 expressing the complex space is 0, the phase value is π/2 when the amplitude value is 0.5, and the phase is π when the amplitude value is 1. That is, the ratio of phase variation value according to the amplitude variation of each amplitude modulation pixel (731, 732, 733 of FIG. 7) is π/1.

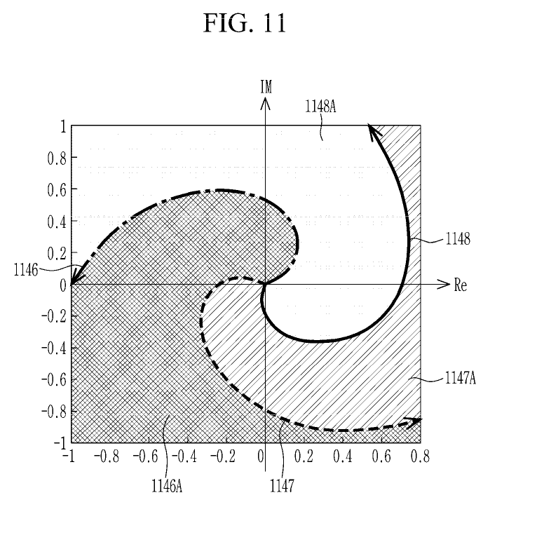

FIG. 11 shows a complex space expressed by a modified unit light vector as shown in FIG. 10.

As shown in FIG. 11, as the amplitude value of each amplitude modulation pixel (731, 732 or 733 of FIG. 7) increases, the phase of each unit light vector 1146, 1147, and 1148 varies. That is, as the amplitude of each amplitude modulation pixel (731, 732 or 733 of FIG. 7) increases, each unit light vector 1146, 1147, and 1148 varies into a vane-shaped vector instead of a straight shape vector.

As the phases of the unit light vectors 1146, 1147, and 1148 vary, complex spaces 1146A, 1147A, and 1148A expressed by the combination of the unit light vectors 1146, 1147, and 1148 may also be changed as shown in FIG. 11.

As the phases of the unit light vectors 1146, 1147, and 1148 vary, the complex spaces 1146A, 1147A, and 1148A expressed by the combination of the unit light vectors 1146, 1147, and 1148 may also be changed as shown in FIG. 11 in response to the phase variation of the unit light vectors 1146, 1147, and 1148, the apparatus for holographic display by complex modulation may determine amplitude values (a, b, and c) of amplitude modulation based on a ratio of the phase variance according to the amplitude variance of each unit light vector (first unit light vector (ê(j0)), second unit light vector (ê(j2π/3)), and third unit light vector (ê(j4π/3))) in response to amplitude modulation on each of the modulation pixels.

For example, the apparatus for holographic display by complex modulation may express a complex hologram using Equation 2 below.

$$x + jy = {ae}^{j π a} + {be}^{j π b + j \frac{2 π}{3}} + {ce}^{j π c + j \frac{4 π}{3}} \qquad [ Equation 2 ]$$

That is, as shown in Equation 2, the apparatus for holographic display by complex modulation may calculate a phase variation value (jπa) to be applied to the first unit light vector (ê(j0)) based on the first amplitude value (a) of the first amplitude modulation pixel, and obtain the first unit light vector (ê(jπa)) where the phase variation value (jπa) is applied.

Also, the apparatus for holographic display by complex modulation may calculate a phase variation value (jπb) to be applied to the second unit light vector (ê(j2π/3)) based on the second amplitude value (b) of the second amplitude modulation pixel, and obtain the second unit light vector (ê(jπb+j2π/3)) where the phase variation value (jπb) is applied. In addition, the apparatus for holographic display by complex modulation may calculate a phase variation value (jπc) to be applied to the third unit light vector (ê(j4π/3)) based on the third amplitude value (c) of the third amplitude modulation pixel, and obtain the third unit light vector (ê(jπc+j4π/3)) where the phase variation value (jπc) is applied.

Next, the apparatus for holographic display by complex modulation may express the complex hologram (x+jy) using a value found by multiplying the first amplitude (a) by the phase delayed first unit light vector (ê(jπa)), a value found by multiplying the second amplitude (b) by the phase delayed second unit light vector (ê(jπb+j2π/3)), and a value found by multiplying the third amplitude (c) by the phase delayed third unit light vector (ê(jπc+j4π/3)).

Conversely, the apparatus for holographic display by complex modulation may determine a value of the first amplitude (a), the second amplitude (b), and the third amplitude c) by using the above Equation 2 that describes a combination of values found by multiplying the first amplitude (a) by the phase delayed first unit light vector (ê(jπa)), a value found by multiplying the second amplitude (b) by the phase delayed second unit light vector (ê(jπb+j2π/3)), and a value found by multiplying the third amplitude (c) by the phase delayed third unit light vector (ê(jπc+j4π/3)) the same way as in the predetermined complex hologram value (x+jy).

Further, the apparatus for holographic display by complex modulation may amplitude-modulate the first phase modulated light wave from the first phase modulation pixel by the determined first amplitude (a) using Equation 2, amplitude-modulate the second phase modulated light wave from the second phase modulation pixel by the determined second amplitude (b) using Equation 2, and amplitude-modulate the third phase modulated light wave from the third phase modulation pixel by the determined third amplitude (c) using Equation 2.

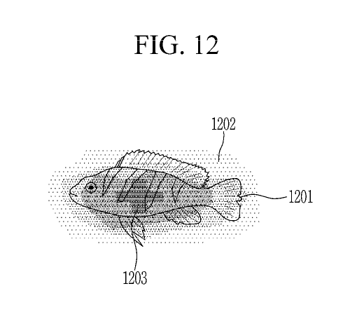

FIG. 12 shows a reproduced hologram according to the conventional art.

As shown in FIG. 12, according to the conventional art, a conjugate component 1202 and a DC component 1203 may occur as well as the hologram 1201 from the light source.

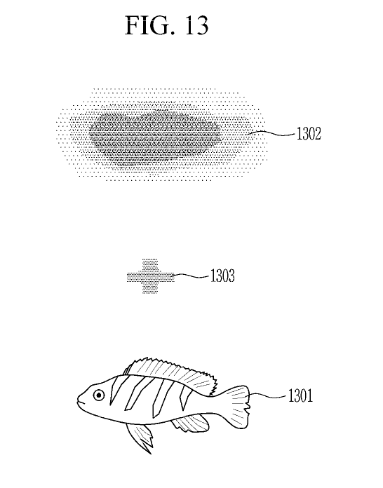

FIG. 13 shows a reproduced hologram according to the conventional art.

As shown in FIG. 13, according to the off-axis method, which is a conventional art for obtaining a phase optical image at an angle to an object light and a reference light, a hologram 1301, a conjugate component 1302, and a DC component 1303 may be separately displayed at a predetermined distance from the light source.

In this case, however, the conjugate component and the DC component are defined as noise when viewed from a desired hologram, and therefore, it is necessary to remove the conjugate component and the DC component through an apparatus for holographic display by complex modulation.

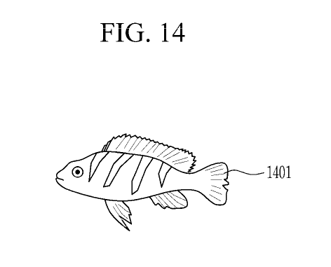

FIG. 14 shows a reconstructed hologram according to an exemplary embodiment of the present invention.

As shown in FIG. 14, an apparatus for holographic display by complex modulation according to an exemplary embodiment of the present invention may display a complex hologram 1401 in a space from which the conjugate component and the DC component are removed from the light source.

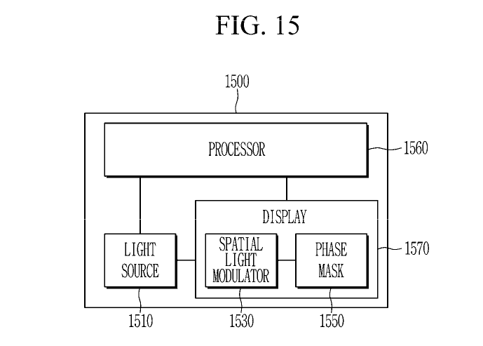

FIG. 15 shows a block diagram of an apparatus for holographic display by complex modulation according to an exemplary embodiment of the present invention.

As shown in FIG. 15, according to an exemplary embodiment of the present invention, an apparatus for holographic display by complex modulation 1500 may include a light source 1510, a display unit 1570, and a processor 1560, and the display unit 1570 may include a spatial light modulator 1530 and a phase mask 1550.

The light source 1510 may emit the light as described above with reference to FIG. 1 to FIG. 14. The light source 1510 generates a laser having a coherence characteristic and outputs the laser to the display unit 1570. The light source may be a diode, and for example, a light emitting diode (LED).

The phase mask 1550 of the display unit 1570 includes a plurality of phase modulation pixels. The plurality of phase modulation pixels may constitute 3 or 4 unit macro pixels, and a plurality of light waves of a plane wave transmitted from the light source 1510 may be phase-modulated into a plurality of unit light waves having the same phase difference (for example, 90 degrees or 120 degrees).

The spatial light modulator 1530 of the display unit 1570 includes a plurality of amplitude modulation pixels. The plurality of amplitude modulation pixels may constitute one macro pixel with three or four phase modulation pixels, and can amplitude-modulate a plurality of light waves.

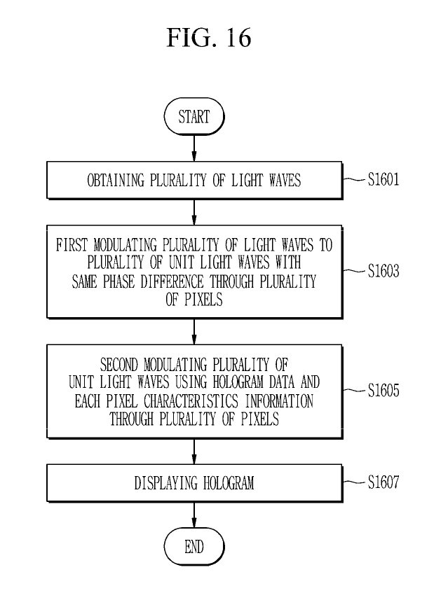

FIG. 16 shows a flowchart illustrating a method for holographic display by complex modulation according to an exemplary embodiment of the present invention.

As shown in FIG. 16, according to an exemplary embodiment of the present invention, in step S1601, the apparatus for holographic display by complex modulation 1500 obtains a plurality of light waves from a light source.

In step S1603, the apparatus for holographic display by complex modulation 1500 may first modulate a plurality of light waves output from the light source to a plurality of light waves having the same phase difference through a plurality of pixels.

In step S1605, the apparatus for holographic display by complex modulation 1500 may second modulate a plurality of pixels through a plurality of unit light waves using hologram data and characteristic information of each pixel. The hologram data represent a complex hologram value to be expressed. The characteristic information of each pixel may include a ratio value of phase delay according to the amplitude value of each pixel.

In step S1607, the apparatus for holographic display by complex modulation 1500 may display holograms in space using unit light waves that are second-modulated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for holographic display by complex modulation, comprising:
a light source configured to output light;
a display configured to display hologram by diffracting the output light through a plurality of pixels; and
a processor configured to control the display to obtain complex hologram data corresponding to the hologram, and modulate the output light based on the complex hologram data and device information of the plurality of pixels.

2. The apparatus of claim 1, wherein
the display includes a plurality of first modulation pixels modulating a phase of the output light and a plurality of second modulation pixels modulating amplitude and phase of the phase modulated light, and
the device information of the plurality of pixels includes phase variation information according to amplitude variation of the plurality of second modulation pixels.

3. The apparatus of claim 2, wherein
the processor obtains a plurality of modulated light waves from the output light using the plurality of first modulation pixels, and displays the hologram by combining the plurality of modulated light waves.

4. The apparatus of claim 3, wherein
the processor modulates the phase of the output light so that the plurality of modulated light waves are evenly distributed in a complex space.

5. The apparatus of claim 4, wherein
the processor determines the magnitude of amplitude modulation of the plurality of second modulation pixels using a phase difference between the plurality of modulated light waves, the complex hologram data, and the phase variation information according to amplitude variation of the plurality of second modulation pixels.

6. The apparatus of claim 2, wherein
the plurality of first modulation pixels include a holographic optical element or a diffractive optical element.

7. The apparatus of claim 2, wherein
the plurality of first modulation pixels and the plurality of second modulation pixels are disposed adjacent to each other.

8. The apparatus of claim 7, wherein
a pixel pitch between the adjacent plurality of first modulation pixels is same as a pixel pitch between the adjacent plurality of second modulation pixels.

9. A method for holographic display by complex modulation using a plurality of pixels, comprising:
outputting coherent light;
modulating an amplitude of the output light based on complex hologram data corresponding to the hologram and device information of the plurality of pixels;
modulating a phase of the amplitude-modulated light;
diffracting the complex modulated light through the plurality of pixels; and
reproducing the hologram using the diffracted light.

10. The method of claim 9, wherein
the device information of the plurality of pixels includes phase variation information according to amplitude variation of the plurality of pixels.

11. The method of claim 10, comprising:
obtaining a plurality of modulated light waves from the output light; and
reproducing the hologram by combining the plurality of modulated light waves.

12. The method of claim 11, further comprising
modulating the phase of the output light so that the plurality of modulated light waves are evenly distributed in a complex space.

13. The method of claim 12, further comprising
determining a magnitude of amplitude modulation using a phase difference between the plurality of modulated light waves, the complex hologram data, and the phase variation information according to amplitude variation of the plurality of pixels.

14. An apparatus for holographic display by complex modulation, comprising:
a light source configured to output coherent unit light;
a display configured to reproduce a unit hologram by diffracting the output unit light through three pixels; and
a processor configured to control the display to obtain complex hologram data corresponding to the unit hologram, and modulate the output unit light based on the complex hologram data and device information of the three pixels.

15. The apparatus of claim 14, wherein
the display includes
a spatial light modulator including three first modulation pixels modulating the amplitude and phase of the output unit light, and
a phase mask including three second modulation pixels modulating the phase of the amplitude-modulated unit light.

16. The apparatus of claim 15, wherein
the device information of the three pixels includes phase variation information according to amplitude variation of the three first modulation pixels.

17. The apparatus of claim 15, wherein
the processor obtains three modulated light waves from the output unit light using the three second modulation pixels, and displays the unit hologram by combining the three modulated light waves.

18. The apparatus of claim 17, wherein
the processor modulates the phase of the output light so that the three modulated light waves divide a complex space into three equal parts.

19. The apparatus of claim 15, wherein
the three first modulation pixels and the three second modulation pixels are disposed adjacent to each other.

20. The apparatus of claim 19, wherein
a pixel pitch between the three adjacent first modulation pixels is greater than a pixel pitch between the three adjacent second modulation pixels, and
the three adjacent second modulated pixels diffract light diffracted to a first angle through the three first modulated pixels to a second angle that is greater than the first angle.
